(19) United States
(12) Patent Application Publication
(10) Pub. No.: US 2004/0020124 A1
(43) Pub. Date: Feb. 5, 2004

(54) Process for maintaining a pure hydrogen stream during transient fuel cell operation

(76) Inventors: Bradley P. Russell, Cary, IL (US); John R. Harness, Elgin, IL (US); Paul G. Blommel, Blue Mounds, WI (US); Daniel R. Sioui, Arlington Heights, IL (US); Suheil F. Abdo, Lincolnshire, IL (US); Kurt M. Vanden Bussche, Lake in the Hills, IL (US); Robert J. Sanger, Chicago, IL (US)

Correspondence Address: JOHN G TOLOMEI, PATENT DEPARTMENT, UOP LLC, 25 EAST ALGONQUIN ROAD, P O BOX 5017, DES PLAINES, IL, 60017-5017, US

(21) Appl. No.: 10/209,486

(22) Filed: Jul. 30, 2002

(51) Int. Cl. C01B 3/24

(52) U.S. Cl. 48/198.3; 48/198.7; 48/127.9; 48/128; 422/107; 422/198; 422/211

(57) ABSTRACT

A method is provided for maintaining low concentration of carbon monoxide in a fuel processor product hydrogen stream during transient operation with a residential fuel cell, particularly during increases in load demand (turn-up). Algorithms have been developed for controlling the air flow to a preferential oxidation reactor and for controlling the rate of direct water injection for rapid steam generation in a water gas shift reactor.

### FIELD OF THE INVENTION

The present invention relates to a hydrogen generating process and, more particularly, to an autothermal reforming (ATR) process that is suitable for use as a hydrogen generation system or as an electric power generation system when used in conjunction with a fuel cell. In particular, the present invention relates to a process for maintaining a low concentration of carbon monoxide in the product stream during variations in operation that occur with residential fuel cells.

### BACKGROUND OF THE INVENTION

The use of fuel cells to generate electrical power for electricity or to drive a transportation vehicle relies upon a supply of hydrogen. Hydrogen is difficult to store and distribute and it has a low volumetric energy density compared to fuels such as gasoline. Therefore, hydrogen for use in fuel cells will often have to be produced at a point near the fuel cell, instead of being produced in a centralized refining facility and distributed like gasoline. Hydrogen generators for fuel cells must be smaller, simpler and less costly than hydrogen plants for the generation of industrial gasses. Furthermore, hydrogen generators for use with fuel cells will need to be integrated with the operation of the fuel cell and be sufficiently flexible to efficiently provide a varying amount of hydrogen as demand for electric power from the fuel cell varies.

Hydrogen is widely produced for chemical and industrial purposes by converting materials such as hydrocarbons and methanol in a reforming process to produce a synthesis gas. Such chemical and industrial production usually takes place in large facilities that operate under steady-state conditions. This is in contrast with hydrogen generators for fuel cells used on a residential scale, which need to accommodate significant fluctuations in throughput, due to changes in electrical demand that are common in residential use.

Steam reforming is often used in large-scale hydrogen production and to produce synthesis gas for conversion into ammonia or methanol. In such a process, hydrogen is extracted from the hydrocarbon and from water.

The reforming reaction is expressed by the following formula:

CH₄+2H₂O=4H₂+CO₂ (1)

where the reaction in the reformer and the reaction in the shift converter are respectively expressed by the following simplified formulae (2) and (3):

CH₄+H₂O═CO+3H₂ (2)

CO+H₂O═H₂+CO₂ (3)

In the water gas shift converter, which typically follows a reforming step, formula (3) is representative of the major reaction.

U.S. Pat. No. 4,869,894 discloses a process for the production and recovery of high purity hydrogen. The process comprises reacting a methane-rich gas mixture in a primary reforming zone at a low steam-to-methane molar ratio of up to about 2.5 to produce a primary reformate, followed by reacting the primary reformate in a secondary reforming zone with oxygen to produce a secondary reformate, comprising hydrogen and oxides of carbon. The secondary reformate is subjected to a high temperature water gas shift reaction to reduce the amount of carbon monoxide in the hydrogen-rich product. The hydrogen-rich product is cooled and processed in a vacuum swing adsorption zone to remove carbon dioxide and to produce a high purity hydrogen stream.

U.S. Pat. No. 5,741,474 discloses a process for producing high purity hydrogen by reforming a hydrocarbon and/or oxygen atom containing hydrocarbon to form a reformed gas containing hydrogen, and passing the reformed gas through a hydrogen-separating membrane to selectively recover hydrogen. The process comprises the steps of heating a reforming chamber, feeding the hydrocarbon along with air and/or steam to the chamber and therein causing both steam reforming and partial oxidation to take place to produce a reformed gas. The reformed gas is passed through a separating membrane to recover a high purity hydrogen stream and the non-permeate stream is combusted to provide heat to the reforming chamber.

Conventional steam reforming plants are able to achieve high efficiency through process integration; that is, by recovering heat from process streams which require cooling. In the conventional large-scale plant this occurs in large heat exchangers with high thermal efficiency and complex control schemes.

Fuel cells are chemical power sources in which electrical power is generated in a chemical reaction. The most common fuel cell is based on the chemical reaction between a reducing agent such as hydrogen and an oxidizing agent such as oxygen. The consumption of these agents is proportional to the power load. Polymers with high protonic conductivities are useful as proton exchange membranes (PEM's) in fuel cells.

The water gas shift reactions and the preferential oxidation reactions are often used for removal of carbon monoxide from fuel processor reformate streams. These processes are described in U.S. Pat. No. 6,299,995 B1, which is hereby incorporated by reference herein in its entirety. The preferential oxidation reaction has the purpose of oxidizing the carbon monoxide to produce carbon dioxide, while a comparatively small proportion of the hydrogen, the desired product, is oxidized to produce water. The low carbon monoxide levels that are desired for use with PEM fuel cells are readily achieved with the prior art processes when operating under steady state operating conditions. However, application of PEM fuel cells to residential power generation, or other applications that provide for intermittent operation, requires the provision of a fuel processor that can maintain low CO levels under transient operating conditions. In particular, it has been found that periods of high CO concentration can occur, generally during periods of increase in throughput of fuel (turn-up).

Depending upon such factors as reformate flow rate, steam injection rate, and catalyst temperature, the carbon monoxide content of the gas exiting the shift reactor can be as low as 0.2 mol-% (dry basis). Hence, shift reactor effluent comprises a bulk mixture of hydrogen, nitrogen, carbon dioxide, water, carbon monoxide, and residual hydrocarbon.

The shift reaction is typically not enough to sufficiently reduce the carbon monoxide content of the reformate to the necessary level—i.e. below about 100 parts per million volume (ppmv) and preferably below 10 ppmv. Therefore, it is necessary to further remove carbon monoxide from the hydrogen-rich reformate stream exiting the shift reactor, prior to supplying it to the fuel cell. It is known to further reduce the carbon monoxide content of hydrogen-rich reformate exiting a shift reactor by a so-called preferential oxidation reaction (also known as “selective oxidation”) effected in a suitable preferential oxidation reactor. A preferential oxidation reactor usually comprises a catalyst bed, which promotes the preferential oxidation of carbon monoxide to carbon dioxide by air in the presence of the diatomic hydrogen, but without oxidizing substantial quantities of the H₂ itself. Desirably, the oxygen required for the preferential oxidation reaction will be no more than about three to four times the stoichiometric amount required to react the CO in the reformate. If the amount of O₂ exceeds about three to four times the stoichiometric amount needed, excessive consumption of H₂ results. On the other hand, if the amount of O₂ is substantially less than about three to four times the stoichiometric amount needed, insufficient CO oxidation will occur.

Preferential oxidation reactors may be either (1) adiabatic (i.e. where the temperature of the reformate (syngas) and the catalyst are allowed to rise during oxidation of the CO), or (2) approximately isothermal (i.e. where the temperature of the reformate (syngas) and the catalyst are maintained substantially constant by heat removal from the reactor during oxidation of the CO). The adiabatic preferential oxidation process may be effected via one or more stages with inter-stage cooling, which progressively reduce the CO content. Temperature control is important, because if the temperature rises too much, methanation, hydrogen oxidation, or a reverse shift reaction can occur. This reverse shift reaction produces more of the undesirable CO, while methanation and excessive hydrogen oxidation negatively impact system efficiencies and can lead to large temperature excursions and reactor instability.

A controlled amount of oxygen (e.g. air) is mixed with the reformate exiting the shift reactor, and the mixture is passed through a suitable catalyst bed known to those skilled in the art.

The processes that have been previously developed have provided satisfactory results in reduction of the CO level below the desired level when operating in a steady state mode. However, it is also necessary to maintain this low level of CO concentration at all times during operation of the fuel processor in order to avoid poisoning of the PEM catalyst. In particular, previous to the present invention, considerable difficulty has been found with a rise in CO levels during turn-up of the fuel processor. During rapid turn up, this proves to be even more of a problem. One reason for the difficulty in maintaining a low level of CO is that the water gas shift reactor takes time to reach the appropriate operating temperature, and there is generally a time lag associated with steam production in the system. Steps need to be taken to overcome this difficulty.

It is an objective of the present invention to solve some of the problems associated with small-scale systems for producing hydrogen for fuel cells. In particular, it is an objective of the present invention to provide a process for maintaining a low carbon monoxide concentration through a combination of water injection into the process stream and increased air flow to the preferential oxidation reactor. It is further an objective of the present invention to provide control algorithms that relate the fuel flow, water injection rate and preferential oxidation air flow and achieve significant improvements to the reduction of carbon monoxide throughout the operation of a fuel processor.

The present invention addresses the above problems and challenges and provides other advantages as will be understood by those in the art in view of the following specification and claims.

### SUMMARY OF THE INVENTION

The hydrogen generation process of the present invention solves the problem of maintaining a low carbon monoxide concentration during transient operation, especially during turn-up. Integrated hydrogen generation and fuel cell systems to generate electricity for residential applications require meeting an electrical demand, which is generally transient. Meeting these transient demands results in transient operation of the hydrogen generator, which requires rapid turn-up and turn-down in order to avoid large energy storage devices such as batteries. During rapid turn-up and turn-down, the heat exchange equipment generally has a time lag and system temperatures and steam production cannot be changed instantaneously. Thus, methods are required to compensate for the inherently slow thermal response of system components.

In one embodiment, the invention is a process for producing electric power from a hydrocarbon feedstock. The process comprises a series of steps. The hydrocarbon feedstock and steam are passed to a convection heated pre-reforming zone at a pre-reforming temperature to produce a pre-reforming effluent. The pre-reforming effluent and a first air stream are passed to a partial oxidation zone in a reaction chamber to produce a partial oxidation effluent. A controlled ratio of water to hydrocarbon is added into the hydrocarbon feedstock and steam. The partial oxidation effluent is passed to a reforming zone disposed in the reaction chamber to produce a reforming effluent comprising hydrogen and carbon monoxide. The reforming effluent is passed to a carbon monoxide reduction zone to produce a hydrogen product. The carbon monoxide reduction zone comprises a water gas shift zone and at least one preferential oxidation reactor. A controlled ratio of air to hydrocarbon feedstock is added to the hydrogen product prior to its entrance into the preferential oxidization reactor. The hydrogen product is passed to a fuel cell zone to produce electric power. The hydrocarbon feedstock processed in the process can include natural gas, LPG, or naphtha.

In another embodiment of the invention, the invention is a method for maintaining low levels of carbon monoxide in the hydrogen product stream from a hydrocarbon fuel processor. This method comprises adjusting a water to hydrocarbon fuel ratio and an air to hydrocarbon fuel ratio in accordance with a predetermined algorithm, wherein said fuel processor comprises a supply of said hydrocarbon fuel, and water and steam supplied to a reactor to produce hydrogen fuel comprising hydrogen and carbon monoxide, followed by the reduction in concentration of said carbon monoxide in said hydrogen fuel by passing the hydrogen fuel first through at least one water gas shift reactor and then through at least one preferential oxidation reactor, wherein said water is added to the hydrocarbon fuel prior to said hydrocarbon fuel entering said reactor, and wherein air is added to said at least one preferential oxidation reactor in accordance with said algorithm, wherein said algorithm comprises determining a target hydrocarbon fuel flow (B) and a current hydrocarbon fuel flow (A), then determining a present difference (D)=(B)−(A), and then comparing said difference (D) with a predetermined value to determine whether said fuel processor is turning up production of hydrogen, turning down production of hydrogen or operating at a steady state mode and wherein a higher ratio of water to fuel and air to fuel is added when said fuel processor is turning up production for a preset period of time then when said fuel processor is operating at a steady state mode and wherein a lower ratio of water to fuel and air to fuel is added when said fuel processor is in a turning down of production.

In another embodiment, the present invention is a process for the generation of hydrogen from a hydrocarbon feedstock for use in a fuel cell system for electric power generation. The process comprises a series of integrated steps. The hydrocarbon feedstock is passed to a preparation module to produce a conditioned feedstock. The conditioned feedstock is passed to a pre-reforming zone containing a pre-reforming catalyst. The pre-reforming zone is in intimate thermal contact with a first heat exchange zone having a steady-state temperature profile to produce a pre-reforming effluent stream comprising hydrogen, nitrogen, carbon monoxide, carbon dioxide and water. Additional water in amounts calculated in accordance with the algorithm used in the practice of the present invention is injected into the pre-reforming effluent stream. The pre-reforming effluent stream at effective partial oxidation conditions is passed to a partial oxidation zone containing a partial oxidation catalyst. In the partial oxidation zone the pre-reforming effluent is contacted with a first air stream to produce a partial oxidation effluent stream. The partial oxidation effluent stream at effective reforming conditions is passed to a reforming zone. The reforming zone contains a reforming catalyst to produce a reforming effluent stream. The reforming effluent stream is withdrawn from the reforming zone at a reforming exit temperature. The reforming effluent stream and a first water stream are passed to a water gas shift reaction zone containing at least one water gas shift catalyst zone. The water gas shift reaction zone is in intimate thermal contact with a second heat transfer zone having a steady-state temperature profile to cool the water gas shift reaction zone by indirect heat transfer to effective water gas shift conditions to produce a hydrogen product stream comprising hydrogen, nitrogen, carbon monoxide, carbon dioxide and water. The hydrogen product stream is passed to an anode side of a fuel cell zone. The fuel cell zone has a cathode side on which an oxygen containing stream is contacted to produce electric power and an anode waste gas comprising hydrogen is withdrawn from the anode side. The anode waste gas is returned to a burner zone wherein the anode waste gas is contacted with a sufficient amount of a second air stream to combust the anode waste gas to produce a flue gas stream at a flue gas temperature. The flue gas stream is passed to the first heat exchange zone to heat the pre-reforming zone to the effective pre-reforming conditions.

### BRIEF DESCRIPTION OF THE DRAWINGS

FIG. 1 is a schematic block flow diagram illustrating the core process of the present invention.

FIG. 2 is a diagram illustrating the process of the present invention including pre and post processing steps.

FIG. 3 is a diagram of the algorithm calculations used to determine the ratios of water injection:fuel and air:fuel.

FIG. 4 is a graph showing the effectiveness of the present invention in the control of carbon monoxide levels.

### DETAILED DESCRIPTION OF THE INVENTION

The process of the current invention uses a hydrocarbon stream such as natural gas, liquefied petroleum gas (LPG), butanes, gasoline, oxygenates, biogas, or naphtha (a gasoline boiling range material) as a feedstock. The invention is particularly useful with a natural gas stream. Natural gas and similar hydrocarbon streams comprising mostly methane, also generally contain impurities (including odorants) such as sulfur in the form of hydrogen sulfide, mercaptans, sulfides, and the like which must be removed prior to introducing the feedstock to the steam reforming zone. The removal of sulfur from the hydrocarbon feedstock may be accomplished by any conventional means including adsorption, chemisorption and catalytic desulfurization. Generally, the type of pre-processing module for the hydrocarbon feedstock before it is charged to the fuel processor will depend on the character or type of hydrocarbon feedstock. Hydrogen sulfide in natural gas can be removed by contacting the natural gas stream with a chemisorbent such as zinc oxide in a fixed bed desulfurization zone. LPG, which comprises propane, butane, or mixtures thereof, generally contains relatively high concentrations of sulfur odorants and the use of a guard bed containing an adsorbent or a chemisorbent to protect the catalyst in the fuel processor may be included.

Water is required by the steam reforming process for use as a reactant and as a cooling medium. In addition for some types of fuel cells, the hydrogen product must be delivered to the fuel cell as a wet gas. This is particularly true with PEM fuel cells, wherein the humidity of the hydrogen product stream is controlled to avoid drying out the PEM membrane in the fuel cell. The water used in the steam reforming process preferably is deionized to remove dissolved metals and anions. Metals which could be harmful to catalysts include sodium, calcium, lead, copper and arsenic. Anions, such as chloride ions, should be reduced or removed from water. Removal of these cations and anions are required to prevent premature deactivation of the steam reforming catalyst or other catalytic materials contained in the fuel processor such as the water gas shift catalyst or the carbon monoxide oxidation catalyst in a carbon monoxide reduction zone. The deionization of the water to be used in the process may be accomplished by any conventional means.

The pre-processed feedstock is admixed with a steam stream to form a pre-reforming admixture and the pre-reforming admixture is passed to a pre-reforming zone for the partial conversion of the pre-treated feedstock to a pre-reformed stream comprising hydrogen, carbon monoxide, carbon dioxide, water, and unconverted hydrocarbons. The steam can be supplied by the indirect heating of water with process heat recovered from various streams, such as ATR effluent or from heat recovered from flue gas resulting from the combustion of anode waste gas. Preferably, the steam to carbon ratio of the pre-reforming admixture is between about 1:1 and about 6:1, and more preferably, the steam to carbon ratio of the pre-reforming admixture is between about 2:1 and about 4:1, and most preferably, the steam to carbon ratio of the pre-reforming admixture comprises about 3:1. The pre-reforming zone contains a pre-reforming catalyst comprising a catalyst base such as alumina with a metal deposited thereon. Preferably, the pre-reforming catalyst includes nickel with amounts of noble metal, such as cobalt, platinum, palladium, rhodium, ruthenium, iridium, and a support such as magnesia, magnesium aluminate, alumina, silica, zirconia, singly or in combination. More preferably, the steam reforming catalyst can be a single metal such as nickel or a noble metal supported on a refractory carrier such as magnesia, magnesium aluminate, alumina, silica, or zirconia, singly or in combination, promoted by an alkali metal such as potassium. The pre-reforming catalyst can be granular and is supported within the steam reforming zone. The pre-reforming catalyst may be disposed in a fixed bed or disposed on tubes or plates within the pre-reforming zone. In the process of the present invention, the pre-reforming zone is operated at effective pre-reforming conditions including a pre-reforming temperature of between about 300° and about 700° C. (572° and 1292° F.) and a pre-reforming pressure of between about 100 and about 350 kPa (14 and 51 psi). More preferably, the pre-reforming temperature ranges between about 350° and about 600° C. (662° and 1112° F.), and most preferably the pre-reforming temperature comprises a temperature between about 350° and about 550° C. (662° and 1022° F.). The pre-reforming reaction is an endothermic reaction and requires heat to be provided to initiate and maintain the reaction.

The pre-reforming zone is in intimate thermal contact with a first heat exchange zone which transfers heat by indirect heat exchange to the pre-reforming zone. The first heat exchange zone is heated by the passage of a burner exhaust stream or flue gas stream from a burner zone. The pre-reformed stream is passed at effective partial oxidation conditions to a partial oxidation zone wherein the pre-reformed stream is contacted with an oxygen-containing stream, or first air stream, in the presence of a partial oxidation catalyst to produce a partial oxidation product. If the pre-reformed stream is not at effective partial oxidation conditions, such as during the startup of the fuel processor when there is insufficient fuel for the burner zone to heat the pre-reforming zone, the pre-reformed stream and the oxygen-containing stream are ignited to begin the partial oxidation reaction in the partial oxidation zone. The partial oxidation product comprises hydrogen, nitrogen, carbon monoxide, carbon dioxide and some unconverted hydrocarbons. The partial oxidation catalyst may be disposed in the partial oxidation zone as a fixed bed or as a monolith. Catalyst compositions suitable for use in the catalytic partial oxidation of hydrocarbons are known in the art (see U.S. Pat. No. 4,691,071, which is hereby incorporated by reference). Preferred catalysts for use in the process of the present invention comprise as the catalytically active component, an element selected from Group VIII noble metal, a Group IVA element and a Group IA or IIA metal of the Periodic Table of the Elements composited on a metal oxide support, wherein the support comprises a cerium-containing alumina. The alumina can be alpha-alumina, or a mixture of alpha-alumina and theta-alumina. Preferably, the cerium is present in the amount of about 0.01 to about 5.0% by weight of the support. Preferably, the Group VIII noble metal in the partial oxidation catalyst is a noble metal selected from the group consisting of platinum, palladium and rhodium. Preferably, the Group IVA element which is present on the partial oxidation catalyst is selected from the group consisting of germanium, lead and tin and the Group IVA element is present in an amount of from about 0.01% to about 5% by weight of the partial oxidation catalyst. Preferably, the Group IA or Group IIA metal is present in the partial oxidation catalyst is selected from the group consisting of sodium, potassium, lithium, rubidium, cesium, beryllium, magnesium, calcium, francium, radium, strontium and barium and the Group IA or Group IIA metal is present in an amount in the range of from about 0.01% to about 10% by weight of the partial oxidation catalyst. The catalytically active metal may also be supported on suitable carrier materials well known in the art, including the refractory oxides, such as silica, alumina, titania, zirconia and mixtures thereof. Preferably, the partial oxidation catalyst is granular and is supported as a fixed catalyst bed within the partial oxidation zone. The partial oxidation catalyst may also be in monolith form. In the process of the present invention, the partial oxidation zone is operated at effective partial oxidation conditions including a partial oxidation temperature of below about 1400° C. (2552° F.) and a low partial oxidation pressure of between about 100 and about 350 kPa (15 and 51 psi). More preferably, the partial oxidation temperature ranges between about 500° and about 1400° C. (932° and 2552° F.), and most preferably the partial oxidation temperature is between about 600° C. and about 1100° C. (1112° and 2012° F.).

The partial oxidation product is passed to the steam reforming zone containing a steam reforming catalyst to produce a reforming effluent stream. Preferably, the steam reforming catalyst includes nickel with amounts of other metal, such as cobalt, platinum, palladium, rhodium, ruthenium, iridium and a support such as magnesia, magnesium aluminate, alumina, silica, zirconia, singly or in combination. More preferably, the steam reforming catalyst can be a single metal such as nickel or a noble metal supported on a refractory carrier such as magnesia, magnesium aluminate, alumina, silica, or zirconia, singly or in combination, promoted by an alkali metal such as potassium. The steam reforming catalyst can be granular and is supported as a fixed catalyst bed within the steam reforming zone. The steam reforming catalyst can also be in a monolithic form within the steam reforming zone. In the process of the present invention, the steam reforming zone is operated at effective reforming conditions including a reforming temperature of below about 700° C. (1292° F.) and a reforming pressure of between about 100 and about 350 kPa (15 and 51 psi). More preferably, the reforming temperature ranges between about 500° and about 700° C. (932° and 1292° F.), and most preferably the reforming temperature is between about 550° and about 650° C. (1022° and 1202° F.). The reforming effluent stream is withdrawn from the reforming zone at a reforming exit temperature of below about 700° C. (1292° F.). The reforming exit temperature is maintained at a value of about 650° C. (1202° F.) by controlling the rate of the supply of the oxygen-containing stream to the partial oxidation zone. In this manner, the reforming exit temperature establishes the hot side temperature for a second heat exchange zone which will be employed to remove heat from the inlet to a water gas shift reaction zone.

The reforming effluent is passed to at least one water gas shift reaction zone which exothermically reacts the carbon monoxide over a shift catalyst in the presence of an excess amount of water to produce additional amounts of carbon dioxide and hydrogen. The following is a description of a two-zone water gas shift reaction zone, although any number of water gas shift reaction zones may be employed to reduce the carbon monoxide level in the H₂ product. The steam reforming effluent is cooled to an effective high temperature shift temperature of between about 400° and about 450° C. (752° and 842° F.) to provide a cooled steam reforming effluent. The cooled steam reforming effluent is passed over a high temperature shift catalyst to produce a high temperature shift effluent. The high temperature shift catalyst is selected from the group consisting of iron oxide, chromium oxide and mixtures thereof. The high temperature shift effluent is cooled to reduce the temperature of the high temperature shift effluent to a temperature of between about 180° and about 240° C. (356° and 464° F.) to effective conditions for a low temperature shift reaction and to provide a cooled high temperature shift effluent. The cooled high temperature shift effluent is passed to a low temperature shift zone and contacted with a low temperature shift catalyst to further reduce the carbon monoxide and produce a low temperature shift effluent. The low temperature shift catalyst comprises cupric oxide (CuO) and zinc oxide (ZnO). Other types of low temperature shift catalysts include copper supported on other transition metal oxides such as zirconia, zinc supported on transition metal oxides or refractory supports such as silica or alumina, supported platinum, supported rhenium, supported palladium, supported rhodium and supported gold. The water gas shift reaction is a mildly exothermic reaction and a portion of the heat of the water gas shift reaction is removed by indirect heat exchange in a second heat exchange zone with a water stream to produce a steam stream. The steam stream is admixed with the treated hydrocarbon feedstock to further conserve thermal energy and provide steam to the pre-reforming zone. The water gas shift effluent stream or hydrogen product comprises less than about 0.5 mol-% carbon monoxide (on a dry basis).

Because carbon monoxide acts as a poison to some fuel cells like the PEM fuel cell, the carbon monoxide concentration in the hydrogen product must be removed, or its concentration reduced for example by oxidation, conversion, or separation, before the hydrogen product can be used in these fuel cells to produce electricity. Options for post-processing of the hydrogen product stream to further reduce the carbon monoxide content include selective catalytic oxidation and methanation. In addition, some fuel cells operate at different levels of hydrogen consumption per pass, or hydrogen efficiencies. For example, some fuel cell arrangements demand high purity hydrogen and consume more than about 80% of the hydrogen per pass, while others consume less than about 70% of the hydrogen per pass and do not require high purity hydrogen. In a case which requires high purity, the pressurized hydrogen product stream is passed to a separation zone comprising a pressure swing adsorption system or a palladium membrane to produce a high purity hydrogen stream (95 to 99.999 mol-% hydrogen) and a separation waste stream comprising unrecovered hydrogen, nitrogen, and carbon oxides. A portion of the high purity hydrogen stream may be used in the hydrodesulfurization zone and the remaining portion of the high purity hydrogen stream is passed to the fuel cell zone. Anode waste gas, along with the separation waste stream is passed to the burner zone.

For fuel cells such as PEM fuel cells which are sensitive to carbon monoxide, the hydrogen product is passed to a carbon monoxide oxidation zone at effective oxidation conditions and contacted with a selective oxidation catalyst to produce a hydrogen product gas stream comprising less than about 40 ppmv carbon monoxide. Preferably, hydrogen product gas stream comprises less than about 10 ppmv carbon monoxide, and more preferably, the hydrogen product gas stream comprises less than about 1 ppmv carbon monoxide. The heat of oxidation produced in the carbon monoxide oxidation zone is removed in a conventional manner by cooling the carbon monoxide oxidation zone by conventional means such as with a water jacket and a cooling water stream. The heat of oxidation may also be recovered with boiling water to generate steam.

For a PEM fuel cell, the hydrogen product gas comprising water at saturation and at a temperature less than about 100° C. (212° F.) is passed to the anode side of a fuel cell zone comprising at least one PEM. The PEM membrane has an anode side and a cathode side, and is equipped with electrical conductors which remove electrical energy produced by the fuel cell when an oxygen containing stream is contacted with the cathode side of the PEM membrane. It is required that the PEM membrane be kept from drying out by maintaining the essentially carbon monoxide free hydrogen product stream at saturation conditions. It is also critical that the PEM membrane be maintained at a temperature less than 100° C. (212° F.). When the PEM membrane is operated to be only about 70 percent efficient in its use of the hydrogen product stream, the fuel cell produces an anode waste gas comprising hydrogen and a cathode waste gas comprising oxygen. Typically, anode waste gas comprises hydrogen, nitrogen and carbon dioxide. The anode waste gas comprises less than about 50 mol-% hydrogen, and the cathode waste gas comprises less than about 15 mol-% oxygen.

A second oxygen-containing gas such as air and the anode waste gas withdrawn from the fuel cell anode side are contacted in the burner zone mentioned hereinabove at effective combustion conditions to maintain a burner exit temperature less than about 700° C. (1292° F.). In this manner, the hydrogen generated by the partial oxidation or steam reforming reaction zones and not consumed by the fuel cell is burned to provide thermal integration of the overall process, and in the same burning step any nitrogen introduced by the use of the partial oxidation zone is thereby rejected.

Previous improvements to designs similar to that described above have produced fuel processors that maintain low carbon monoxide levels under steady-state operating conditions. However, this low level of carbon monoxide impurity has proven much more difficult to maintain under transient operating conditions and in particular upon turn-up in fuel throughput. This problem has been reported to be common throughout the industry.

A favorable configuration of the water gas shift reactor is as an annular reactor that is submerged in boiler water. This allows for efficient recovery of steam for use in the system and to maintain a favorable temperature profile for the reactions. For a given throughput of fuel, there is an optimum water gas shift temperature, which is determined from a balance of kinetics and equilibrium with catalyst activity increasing with temperature, but equilibrium level of CO increasing with decreasing temperature for this exothermic reaction. It appears that an optimal average water gas shift temperature would be in the range of about 250° to 300° C. (482° to 572° F.), depending on throughput. However, there is no easy control of the water gas shift reactor temperature, apart from varying the water level in the boiler, with a submerged reactor design. It appears that the water gas shift reaction temperature is well below the optimal operating temperature except near 100% of design throughput. It has now been found that a two-stage preferential oxidation reactor produces improved levels of carbon monoxide with improved dissipation of heat and a maintaining of suitable temperatures, compared to a single-stage preferential oxidation reactor. The ruthenium-based preferential oxidation catalyst tends to produce significant methanation reaction when temperatures exceed about 170° C. (338° F.) in the preferential oxidation reactor. As a result of this, it was found beneficial to use a two-stage preferential oxidation reactor with air injection split between the two stages. The preferential oxidation reactors are annular reactors that are submerged in boiler water for efficient cooling and for additional steam generation. It has been found that the use of the two reactors allows the operating temperature to be limited to the range of 110° to 160° C. (230° to 320° F.). The potential to initiate methanation reactions is thus reduced and the risk of associated temperature runaway is as well. Also, it is beneficial to split the flow of the air, so that one-half of the air flow enters into each of the pref ox reactors.

A significant aspect of the present invention is the algorithm for control of the ratio of the preferential oxidation air:hydrocarbon feed ratio and the water injection:hydrocarbon feed ratio. The feed is the original natural gas stream flow as employed in the practice of this invention. In general, these ratios are highest when the throughput of feed is increasing, less during steady state operation and even lower during a turn-down of the operation. In determining the appropriate ratio to employ, a flow target is determined for the particular apparatus and then the present feed flow is measured. The difference in these two numbers is determined. When the number is greater than a predetermined value, then a greater volume of air is added to the preferential oxidation reactors and a greater amount of water is injected into the feed line. When the flow target is reached, a timer is initiated and the air:fuel and water:fuel ratios are maintained at their respective values until the timer expires or until another flow target is requested. When the timer expires, the respective ratios are reset to their steady state values. In general, the preferential oxidation air and the water injection ratios are twice as high during turn-up as during turn-down. The steady state ratio is about 25% higher than the turn-down ratio. All ratios are calculated as molar ratios of air:hydrocarbon fuel and water:hydrocarbon fuel.

This method comprises adjusting a water to hydrocarbon fuel ratio and an air to hydrocarbon fuel ratio in accordance with a predetermined algorithm, wherein said fuel processor comprises a supply of said hydrocarbon fuel, and water and steam supplied to a reactor to produce hydrogen fuel comprising hydrogen and carbon monoxide, followed by the reduction in concentration of said carbon monoxide in said hydrogen fuel by passing the hydrogen fuel first through at least one water gas shift reactor and then through at least one preferential oxidation reactor, wherein said water is added to the hydrocarbon fuel prior to said hydrocarbon fuel entering said reactor, and wherein air is added to said at least one preferential oxidation reactor in accordance with said algorithm, wherein said algorithm comprises determining a target hydrocarbon fuel flow (B) and a current hydrocarbon fuel flow (A), then determining a present difference (D)=(B)−(A), and then comparing said difference (D) with a predetermined threshold value to determine whether said fuel processor is turning up production of hydrogen, turning down production of hydrogen or operating at a steady state mode and wherein a higher ratio of water to fuel and air to fuel is added when said fuel processor is turning up production for a preset period of time then when said fuel processor is operating at a steady state mode and wherein a lower ratio of water to fuel and air to fuel is added when said fuel processor is in a turning down of production. The following Table 1 illustrates sample ratios for the air:fuel and water:fuel in accordance with the present invention for natural gas fuel. These molar ratios may be determined by experimentation. These ratios are specific to natural gas feed and would be higher for heavier fuels, such as LPG.

TABLE 1

| | Turn- | | |
|---|---|---|---|
| | up Ratio of | Turn-down Ratio | Steady State Ratio |
| | Air:Feed and | of Air:Feed and | of Air:Feed and |
| | Water:Feed | Water:Feed | Water:Feed |
| Air:Feed for each | 0.14 | 0.07 | 0.10 |
| preferential | | | |
| oxidation stage | | | |
| Water:Feed | 1.00 | 0.20 | 0.40 |

### DETAILED DESCRIPTION OF THE DRAWINGS

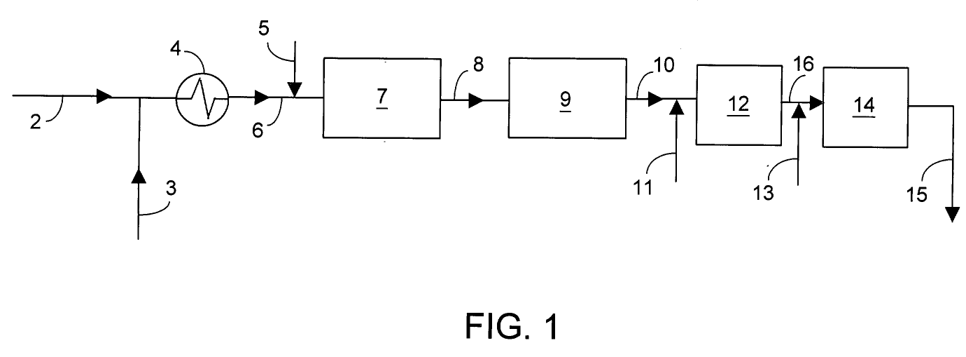

Referring to FIG. 1, which illustrates a simplified schematic of a hydrogen fuel processor for use with a fuel cell, a hydrocarbon (most often natural gas) and steam feed in a line 2 is passed to a preheat exchanger 4. Water feed in a line 3 for injection of a desired flow of water enters the line 2, prior to entrance into the preheat exchanger, which may incorporate a pre-reforming zone. A pre-reforming effluent stream is withdrawn from the preheat exchanger 4 in a line 6, with addition of a measured quantity of a first air stream 5 to the line 6 which leads to an autothermal reforming (ATR) reactor 7. In the ATR reactor 7, at least a portion of the pre-reforming effluent stream is converted to produce an ATR reactor effluent stream comprising hydrogen, nitrogen, carbon monoxide, carbon dioxide and water. The ATR reactor effluent stream is withdrawn from the ATR reactor 7 and passed through a line 8 to a water gas shift reactor 9. The water gas shift reactor 9 contains at least one water gas shift catalyst zone and provides for the conversion of carbon monoxide to carbon dioxide to produce a hydrogen product stream having a low level of CO impurities. The hydrogen product stream is withdrawn from the water gas shift reactor 9 in a line 10. If the fuel cell is of a type that is sensitive to carbon monoxide, the concentration of carbon monoxide needs to be further reduced. In the practice of the present invention, selective oxidation techniques (also known as preferential oxidation) are preferred for the further reduction in level of carbon monoxide. For example, reduction of the carbon monoxide concentration to a level of less than 10 ppmv is required for PEM-type fuel cells, while phosphoric acid fuel cells have a higher carbon monoxide tolerance. As shown in FIG. 1, the hydrogen product stream passes through the line 10 into at least one preferential oxidation reactor 12. In some embodiments of the invention, a second preferential oxidation reactor, 14, as illustrated herein, is provided with the hydrogen product stream passing through a line 16. A measured flow of air is added to the hydrogen product stream through a line 11 and through a line 13 when the second preferential oxidation reactor 14 is present. In general, the volume of air is split equally between the two preferential oxidation reactors. The hydrogen product stream leaves the preferential oxidation reactor (12) or preferential oxidation reactor 14 when two units are used and is passed to an anode side of a fuel cell through a line 15, while an oxygen containing stream such as air is passed to a cathode side of the fuel cell and an anode waste stream which is now depleted in hydrogen relative to the hydrogen product stream is withdrawn from the fuel cell.

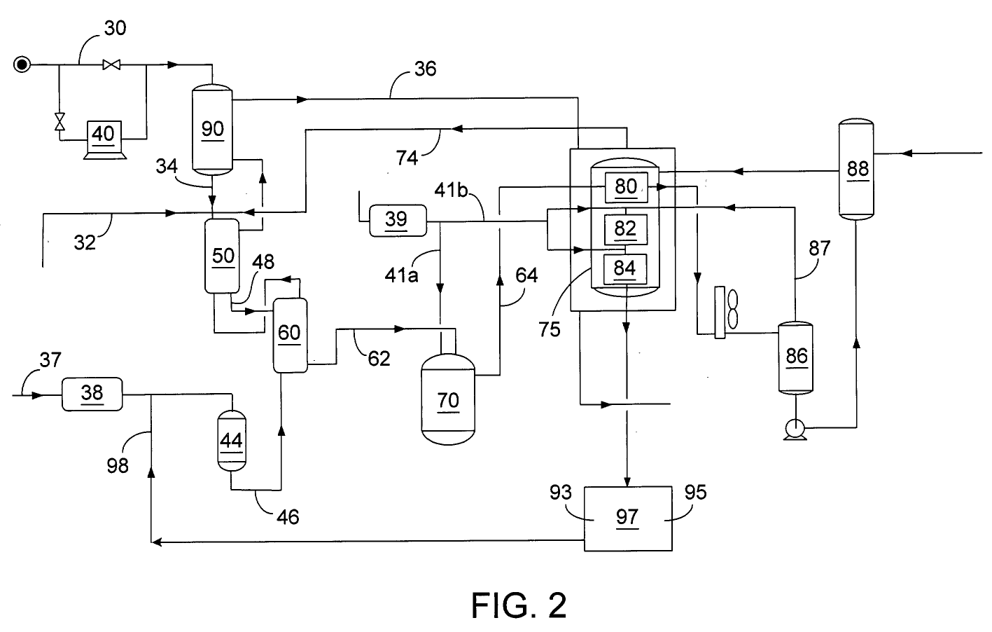

FIG. 2 represents a system for conversion of a hydrocarbon feedstock such as a natural gas stream in a line 30 to electric power using a fuel cell 97. Referring to FIG. 2, a natural gas stream in the line 30 is passed to a treater 90 comprising a desulfurization zone or zone for removal of other impurities. The desulfurization zone contains a sorbent for the removal of impurities such as sulfur compounds including hydrogen sulfide and mercaptans. The desulfurization sorbent is selected from the group consisting of zeolites, activated carbon, activated alumina, zinc oxide, mixtures thereof or other materials known to those skilled in the art as useful in removal of impurities from natural gas. A processed natural gas stream is removed from the treater zone in a line 34. Water can be added to the stream through a line 32, as necessary. A natural gas compressor 40 is shown for maintaining the flow of gas feed to the system. The treated gas feed goes through line 34. Steam from the boiler 75 passes through a steam line 74 to be combined with the treated gas feed in the line 34. An additional amount of water can be injected into the line 34. The amount of water injected into the system is calculated in accordance with the present invention and is dependent upon the stage of operation of the fuel processor. The feed in the line 34 that now contains a mixture of treated gas feed, steam and injected water now proceeds to a vaporizer 50 to produce steam from the injected water. The vaporizer 50 comprises a plate-type heat exchanger. From the vaporizer 50, the gas feed/steam mixture passes through a line 48 to a pre-reformer 60. The pre-reformer zone contains a pre-reforming catalyst selected from the group consisting of nickel on alumina and the like. The pre-reformer 60 is in intimate thermal contact with a heat exchange zone which supplies heat by indirect heat exchange in the convection temperature range to heat the pre-reformer 60. A pre-reforming effluent stream is withdrawn from the pre-reformer 60 in a line 62. A first air stream 37 passes through a blower 38 and is added to an anode waste gas stream 98 and then is heated in a burner 44. In other embodiments of the present invention, the anode waste gas stream 98 may be replaced with a portion of the gas that passes through the treater 90. This produces a heated flue gas stream 46 that provides the heat to the heat exchange zone in intimate contact with the pre-reformer 60.

From the pre-reformer 60, the pre-reforming effluent stream passes through the line 62 to a combined partial oxidation reactor/reformer, also known as an autothermal reformer (ATR reactor) 70. The pre-reforming effluent stream is passed to a partial oxidation zone at effective partial oxidation conditions including a partial oxidation temperature between about 550° and about 900° C. (932° and 1652° F.) and a partial oxidation pressure between about 100 to about 350 kPa (I5 to about 50 psi). Either simultaneously with the introduction of the pre-reforming effluent or as a partial oxidation feed admixture combined with the pre-reforming effluent stream, an air stream in a line 41a is introduced to the ATR reactor 70. A blower 39 is used to create the air stream in the line 41a. The partial oxidation zone within the ATR reactor contains a partial oxidation catalyst. In the partial oxidation zone, at least a portion of the pre-reforming effluent stream is converted to produce a partial oxidation effluent stream comprising hydrogen, nitrogen, carbon monoxide, carbon dioxide, water and unreacted hydrocarbon. The partial oxidation effluent is passed to a reforming zone within the ATR reactor 70. The reforming zone contains a reforming catalyst. In the reforming zone, the partial oxidation effluent stream undergoes a further conversion to produce a reforming effluent stream comprising hydrogen, nitrogen, carbon monoxide, carbon dioxide and water. The partial oxidation zone and the main reforming zone are combined into a single combined reaction zone comprising the ATR reactor 70.

The reforming effluent stream now goes through a line 64 to a water gas shift reactor 80 which contains at least one water gas shift catalyst zone and provides for the reduction in concentration of carbon monoxide to produce a hydrogen product stream. The hydrogen product stream is withdrawn from the water gas shift reactor 80 to then be treated in one or more preferential oxidation reactors 82, 84. The water gas shift reaction is a mildly exothermic reversible reaction and must be cooled to maintain a suitable reaction temperature. The water gas shift reactor 80 is cooled by indirect heat exchange with a second heat exchange zone, shown herein as the boiler 75. As practiced in the preferred embodiment of the present invention, the boiler 75 produces the steam that goes through the line 74 and enters the line 34 as described above to be admixed with the hydrocarbon feed and the additional water injected into the system.

As shown in FIG. 2, the hydrogen product stream passes through a line 87 to a knock-out pot 86 where the hydrogen product stream is cooled by room temperature air or another cooling means in order to condense and remove water. The water may be recycled to a water reservoir 88 and returned to the boiler 75 or the water may be discarded. The hydrogen product stream is then sent to the line 87 to a preferential oxidation reactor zone shown herein as the preferential oxidation reactors 82, 84. A second air stream 41b is added to the preferential oxidation reactors 82, 84. Equal volumes of air may be sent to each preferential oxidation reactor or different amounts as calculated appropriate for maximum reduction of carbon monoxide level. The amount of air added to the preferential oxidation reactors 82, 84 is calculated in accordance with the present invention. The preferential oxidation reactors 82, 84 may be positioned in an annular arrangement in order to maximize surface area in contact with the water within the boiler 75. The preferential oxidation reactors 82, 84 contain a preferential oxidation catalyst to convert virtually all of the remaining carbon monoxide to carbon dioxide. After being treated in the preferential oxidation reactor, the final hydrogen product stream passes to an anode side 93 of the fuel cell 97 along with an oxygen containing stream (air, not shown) that enters a cathode side 95 of the fuel cell 97 wherein the hydrogen and oxygen react to produce electric current.

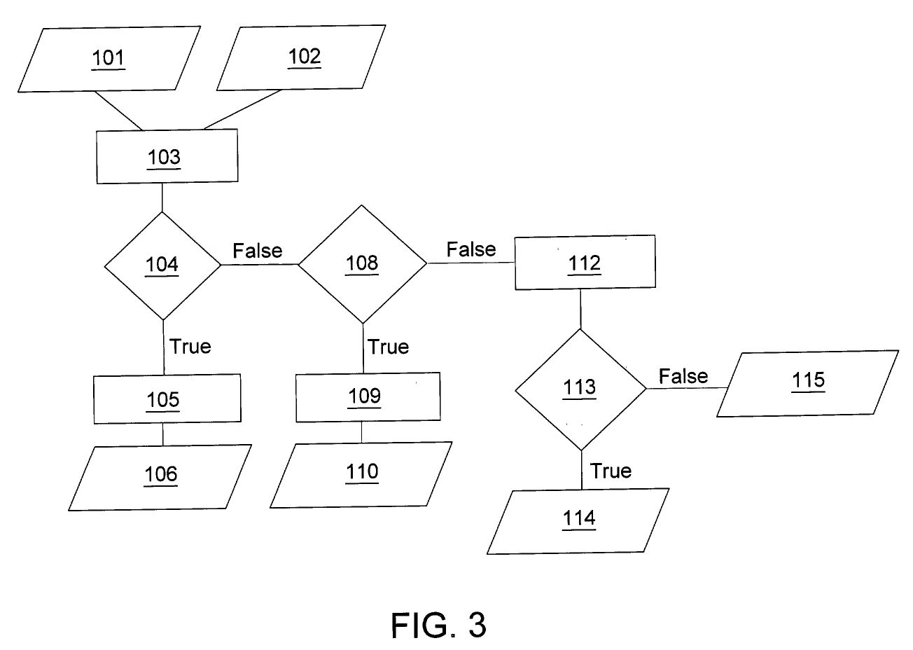

In FIG. 3 is illustrated an algorithm for control of the preferential oxidation reactor air:hydrocarbon feed ratio and the water injection:hydrocarbon feed ratio. In a block 101 is shown the hydrocarbon feed flow target set point B which depends upon the hydrogen output desired from the fuel cell or other uses of the hydrogen product. In a block 102 is the current set point for hydrocarbon feed flow A. In a block 103 is the equation D=B−A. In a decision block 104, the difference D is compared with a pre-determined threshold value. If D is greater than zero and D is greater than the threshold value (True), then the fuel processor is considered in a turn-up mode and the algorithm passes to block 105. In block 105, the air:fuel or water:fuel ratio is set to an appropriate value for turn-up (see Table 1). Also in block 105, a timer is reset to zero. Control execution then passes to block 106, where the respective air or water flow set point is output to the controller. Referring again to block 104, if D is less than the threshold value (False), then the algorithm passes to block 108. In the decision block 108, if D is less than zero and the absolute value of D is greater than the threshold value (True), then the fuel processor is considered in a turn-down mode and the algorithm passes to block 109. In block 109, the air:fuel or water:fuel ratio is set to an appropriate value for turn-down (see Table 1). Also in block 109, a timer is reset to zero. Control execution then passes to block 110, where the respective air or water flow set point is output to the controller. Referring again to block 108, if D is greater than the threshold value (False), then the algorithm passes to block 112. In block 112, a timer is initiated and the algorithm passes to block 113. In the decision block 113, if the timer has not expired (True), then the algorithm passes to block 114. In block 114, the air:fuel or water: fuel ratio is maintained at the respective turn-up or turn-down value. When the timer expires in block 113 (False), the algorithm passes to block 115. In block 115, the air:fuel or water:fuel ratio is reset to the respective value for steady state operation (see Table 1).

The control algorithm in FIG. 3 executes in a continuous fashion, thereby providing an appropriate air:fuel or water:fuel ratio for the particular operating mode of the fuel processor (turn-up, turn-down, or steady state). The timer function allows the respective ratios to be maintained at the turn-up or turn-down values for a period of time after the turn-up or turn-down has been completed. It has been found that this delay in resetting the respective ratios to their steady state values after completing a ramp-up is essential for maintaining a low carbon monoxide concentration.

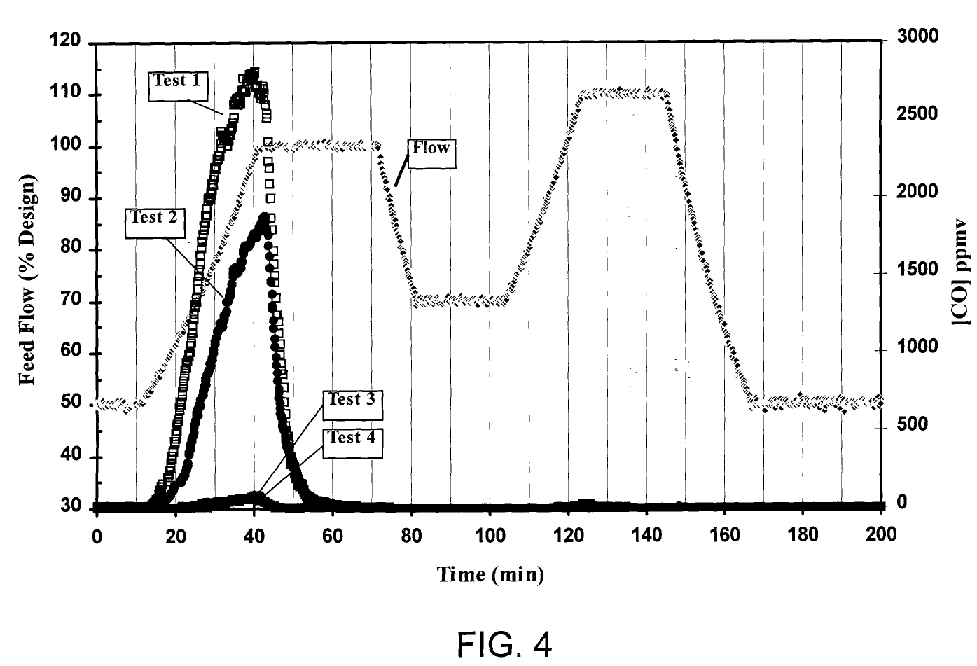

In FIG. 4 is shown the effect of the use of the algorithms of the present invention in control of the carbon monoxide level through variations in fuel flow. As shown on the chart, feed flow in percent of design capacity is varied from 50 to 110% with concentration of carbon monoxide shown for four test runs. In Test 1, the control test, where the preferential oxidation reactor air to natural gas fuel ratio was held constant and where there was no water injection, there was a very significant peak shown of CO level to above 2500 ppmv. In Test 2, a constant ratio of water to feed and a constant ratio of air to feed was used and there was somewhat less carbon monoxide produced as a result of the water injection, but the level was still much more than acceptable. In Tests 3 and 4, the preferential oxidation air was varied in accordance with the algorithm of the present invention as well as the addition of water. The carbon monoxide spike was greatly reduced in Tests 3 and 4.

### EXAMPLE

A series of tests was performed using an apparatus, essentially as shown in FIG. 2, to test the effectiveness of the algorithm for water injection and preferential oxidation air. The feed flow of natural gas was increased from 50% of design to 100% of design level in 30 minutes. The feed flow was then held constant at 100% for 30 minutes before ramping down to 70% in 10 minutes. After holding at 70% for 20 minutes, the feed flow was increased to 110% over a 20-minute interval. The feed was held at 110% for 20 minutes prior to finally ramping down to 50% in 22 minutes. Ramping of feed flow was performed automatically with an algorithm that keeps the percentage change constant to provide an exponential flow vs. time curve.

Prior to each test, the unit was operated at a 50% flow steady-state condition. Four tests were performed. Test 1 was performed with a constant preferential oxidation air:natural gas feed ratio and no water injection. Tests 2, 3 and 4 all included water injection at a constant water:feed ratio of 1.0. Test 2 used a constant preferential oxidation air:feed ratio, while Tests 3 and 4 included preferential oxidation air at a ratio to feed determined in accordance with the algorithm used in the present invention. The ratio of air:feed was higher on turn-up and reduced on turn-down.

Carbon monoxide concentration in the product stream was continuously monitored with an infrared detector and the results are shown in FIG. 4. There was a large CO spike in Test 1 during the initial turn-up of the feed, peaking near the end of the ramping up at 2800 ppmv. In Test 2, the addition of the water injection reduced the initial CO spike significantly, but the maximum remained high, at 1900 ppmv. The combination of the water injection and the preferential oxidation air algorithm almost eliminated the initial spike of CO—the peak maxima were 90 ppmv and 70 ppmv for Tests 3 and 4, respectively. In order to compare results, the peaks were integrated according to the formula I=∫(Feed Flow)×y_{co}^{dt} where y_{co} is the CO concentration. The integral I is roughly proportional to the amount of CO that would be deposited on the fuel-cell anode. Integrated results, normalized with respect to Test 1, are given in the following Table 2. All data for y_{co}>20 ppmv were included in the integration.

TABLE 2

| Test No. | I |
|---|---|
| 1 | 1.00 |
| 2 | 0.59 |
| 3 | 0.021 |
| 4 | 0.013 |

What is claimed is:

1. A method for maintaining low levels of carbon monoxide in a hydrogen fuel processor, said method comprising adjusting a water to hydrocarbon fuel ratio and an air to hydrocarbon fuel ratio in accordance with a predetermined algorithm, wherein said fuel processor comprises a supply of said hydrocarbon fuel, and water and steam supplied to a reactor to produce hydrogen fuel comprising hydrogen and carbon monoxide, followed by the reduction in concentration of said carbon monoxide in said hydrogen fuel by passing said hydrogen fuel first to at least one water gas shift reactor and then to at least one preferential oxidation reactor, wherein said water is added to the hydrocarbon fuel prior to said hydrocarbon fuel entering said reactor, and wherein air is added to said at least one preferential oxidation reactor in accordance with said algorithm, wherein said algorithm comprises determining a target hydrocarbon fuel flow (B) and a current hydrocarbon fuel flow (A), then determining a present difference (D)=(B)−(A), and then comparing said difference (D) with a predetermined threshold value to determine whether said fuel processor is turning up production of hydrogen, turning down production of hydrogen or operating at a steady state mode and wherein a higher ratio of water to fuel and air to fuel is added when said fuel processor is turning up production for a preset period of time than when said fuel processor is operating at a steady state mode and wherein a lower ratio of water to fuel and air to fuel is added when said fuel processor is in a turning down of production mode.

2. The method of claim 1 wherein said target hydrocarbon fuel flow and current fuel flow are measured periodically and said difference is then calculated to determine whether to increase, decrease or not change said ratios of water to fuel and air to fuel.

3. The method of claim 1 wherein upon a change from said turning up mode or said turning down mode to said steady state mode, there is a delay for a preset period of time prior to commencement of said predetermined ratio for said steady state mode.

4. The method of claim 1 wherein the fuel processor contains at least two preferential oxidation reactors, wherein an approximately equal flow of air is added to each of said preferential oxidation reactors.

5. The method of claim 1 wherein said preferential oxidation reactors are submerged in water within a boiler.

6. The method of claim 1 wherein after said hydrogen fuel passes through said preferential oxidation reactors, said hydrogen fuel contains no more than 50 ppmv carbon monoxide at any time during operation of said preferential oxidation reactors.
